(19) United States
(12) Patent Application Publication
(10) Pub. No.: US 2014/0358705 A1
(43) Pub. Date: Dec. 4, 2014

(54) CONTROL OF VENDING MACHINES

(71) Applicant: 24Vend Ltd, Basingstoke (GB)

(72) Inventors: Neil Harrington, Basingstoke (GB); Gillian White, Basingstoke (GB)

(73) Assignee: 24Vend Ltd, Basingstoke (GB)

(21) Appl. No.: 14/162,402

(22) Filed: Jan. 23, 2014

(30) Foreign Application Priority Data
May 30, 2013 (GB) 1309680.5

(51) Int. Cl. G07F 11/00; G06Q 30/06; G06F 17/30; G06Q 20/20

(52) U.S. Cl. CPC G07F 11/00; G06Q 20/20; G06Q 30/0623; G06F 17/30345
USPC 705/16; 705/26.61; 707/609; 700/236

(57) ABSTRACT

Methods and apparatus for control of vending machines by a user equipment. The methods and apparatus comprise a user device comprising an identification unit configured to obtain data identifying a vending machine from an identification unit of the vending machine. The user device further comprises a communication unit configured to query a database to obtain data relating to the content of the identified vending machine, and a user interface configured to present the obtained data to a user and to receive a user input relating to the content of the identified vending machine. The communication unit of the user device is configured to transmit to the database updated data based on the user input and relating to the content of the vending machine.

### TECHNICAL FIELD

The invention relates to methods and apparatus for control of vending machines and/or maintaining a record of the content of vending machines. In particular, the invention relates to, but is not limited to, methods and apparatus for control of vending machines using a user device.

### BACKGROUND

Methods of paying by mobile phone are gaining ground in the vending industry but outside of Scandinavia, where it is quite common, they have yet to be adopted into mainstream vending systems. Payment using SMS or by e-wallet is predicted to be a major driver of alternative electronic payment in the coming years.

In addition, many vending machines that exist today include an electronic memory to capture data relating to payments and to record and count the number of vends as well as a wealth of additional event information. This information is sometimes accessed by the keypad on the machine, sometimes by a printer and sometimes by either a terminal device or a remote telemeter which may transmit the data to a central server.

The need for telemetry and for online transactions using cards or other electronic payments has driven a rise in the number of machines that are connected to communications networks, such as a telephone network or the Internet. Such connections may be made through wired or wireless connections, such as 3G or GPRS systems. This allows information to be transmitted to and from the vending machine and essentially means that vending machines can be directly connected to the Internet.

### SUMMARY

The inventors have appreciated that certain problems exist in current vending machines and methods of operating vending machines. The invention aims to mitigate one or more of these problems. For example, there are moves towards having advanced displays on vending machines that allow information to be provided to a user. However, such displays are expensive and vulnerable to vandalism. Additionally, it is desirable to have an accurate real time record of the contents of a vending machine, which may be stored on a central server via the Internet.

According to an aspect of the invention, there is provided a user device. The user device may be for controlling a vending machine. The user device comprises an identification unit configured to obtain data identifying a vending machine. The user device comprises a communication unit configured to query a database to obtain data relating to the content of an identified vending machine. The user device comprises a user interface configured to present the obtained data to a user and receive a user input relating to the content of an identified vending machine. The communication unit is further configured to transmit to a database updated data based on the user input and relating to the content of an identified vending machine.

For the avoidance of doubt, as used herein, the term “transmit” encompasses both wired and wireless communication.

Optionally, the data relating to the content of the vending machine comprises the content of the vending machine, and the user interface comprises a display configured to display the contents of an identified vending machine to a user.

Optionally, the display is configured to display the contents of the vending machine in a layout corresponding to the layout of the contents in the vending machine.

Optionally, the user input comprises a selection of an item contained in an identified vending machine, and the communication unit is further configured to transmit an instruction to the identified vending machine to vend the selected item.

Optionally, the communication unit is configured to transmit the instruction to vend to a machine interface of the vending machine.

Optionally, the updated data comprises data indicating that the selected item has been vended and is no longer contained in the vending machine.

Optionally, the user device further comprises a payment unit configured to pay a vendor for the selected item.

Optionally, the payment unit is configured to make payment using at least one of: credit or debit card information; and account information relating to a network provider service associated with the user device.

Optionally, the user input comprises amendments to the data relating to the content of an identified vending machine.

Optionally, the updated data comprises data indicating the content and location of items in the vending machine.

Optionally, the data obtained from the database comprises product information relating to one or more items contained in the vending machine, wherein the product information is selectably displayed to the user.

Optionally, the product information comprises one or more of: pricing information; special offers; nutritional information; ingredient information; allergen information; and best before date information.

Optionally, the identification unit comprises an communication part configured to establish a communication link with a vending machine to obtain information identifying the vending machine.

According to the invention in a further aspect, there is provided a method for operation of a user device. The method comprises obtaining data identifying a vending machine. The method comprises querying a database to obtain data relating to the content of an identified vending machine. The method comprises presenting the obtained data to a user and receiving a user input relating to the content of an identified vending machine. The method comprises transmitting to a database updated data based on the user input and relating to the content of an identified vending machine.

According to the invention in a further aspect, there is provided a non-transitory computer readable medium comprising computer readable code configured when read by a computer to undertake the method described above.

According to the invention in a further aspect, there is provided a vending system. The vending system comprises a user device comprising an identification unit configured to obtain data identifying a vending machine from an identification unit of the vending machine. The user device further comprises a communication unit configured to query a database to obtain data relating to the content of the identified vending machine, and a user interface configured to present the obtained data to a user and to receive a user input relating to the content of the identified vending machine. The communication unit of the user device is configured to transmit to the database updated data based on the user input and relating to the content of the vending machine.

Optionally, the user input comprises a selection of an item to vend from the vending machine, and the communication unit of the user device is configured to transmit an instruction to the identified vending machine to vend the selected item.

Optionally, the communication unit of the user device is configured to transmit the instruction to vend to a machine interface of the vending machine.

Optionally, the machine interface is configured to receive an instruction to vend from the user device, generate a converted instruction to vend in a format understandable by a vending controller of the vending machine and transmit the converted instruction to vend to the vending controller.

Optionally, the machine interface is configured to generate a converted instruction to vend that mimics an instruction from a keypad of a user interface of the vending machine.

According to the invention in a further aspect, there is provided a method comprising identifying a vending machine. The method also comprises querying a database to obtain data relating to the content of an identified vending machine. The method further comprises presenting the obtained data to a user and receiving a user input relating to the content of the vending machine. The method further comprises transmitting to a database updated data based on the user input and relating to the content of the vending machine. The method further comprises updating the database based on the updated data.

According to the invention in a further aspect, there is provided a non-transitory computer readable medium comprising computer readable code configured when read by a computer to undertake the method described above.

According to the invention in a further aspect, there is provided a vending machine. The vending machine comprises an identification unit for providing information identifying the vending machine to a user device. The vending machine comprises a communication unit configured to receive a vending instruction from a user device, the vending machine being configured to vend an item based on the received instruction.

Optionally, the vending machine further comprises a machine interface configured to receive an instruction to vend from a user device, generate a converted instruction to vend in a format understandable by a vending controller of the vending machine and transmit the converted instruction to vend to the vending controller.

Optionally, the machine interface is configured to generate a converted instruction to vend that mimics an instruction from a keypad of a user interface of the vending machine.

### BRIEF DESCRIPTION OF THE DRAWINGS

Exemplary embodiments of the invention are described herein with reference to the accompanying drawings, in which:

FIG. 1 is a schematic representation of a system for vending items from a vending machine;

FIG. 2 is a schematic representation of a user device;

FIG. 3 is a schematic representation of a vending machine;

FIG. 4 is a flow chart of a method;

FIG. 5 is a schematic representation of a user device;

FIGS. 6 and 7 are exemplary screen shots from a user device; and

FIG. 8 is a flow chart of a method.

### DESCRIPTION

Generally, disclosed herein are methods and apparatus for controlling a vending machine from a user device and for maintaining a record of vending machine content using a user device. The user device is able to identify a vending machine, retrieve data relating to the content of the vending machine and update the data based on a user input.

Vending machines may be connected to a telecommunications network, such as the Internet. Typically, the information transmitted across a network has been transmitted by the vending machine and consists of sales data, fault reporting data and transaction data. Occasionally, data can be transmitted to a vending machine to change pricing of items where dynamic pricing is enabled. In addition, a few advanced machines can also change recipes in hot drinks machines for example.

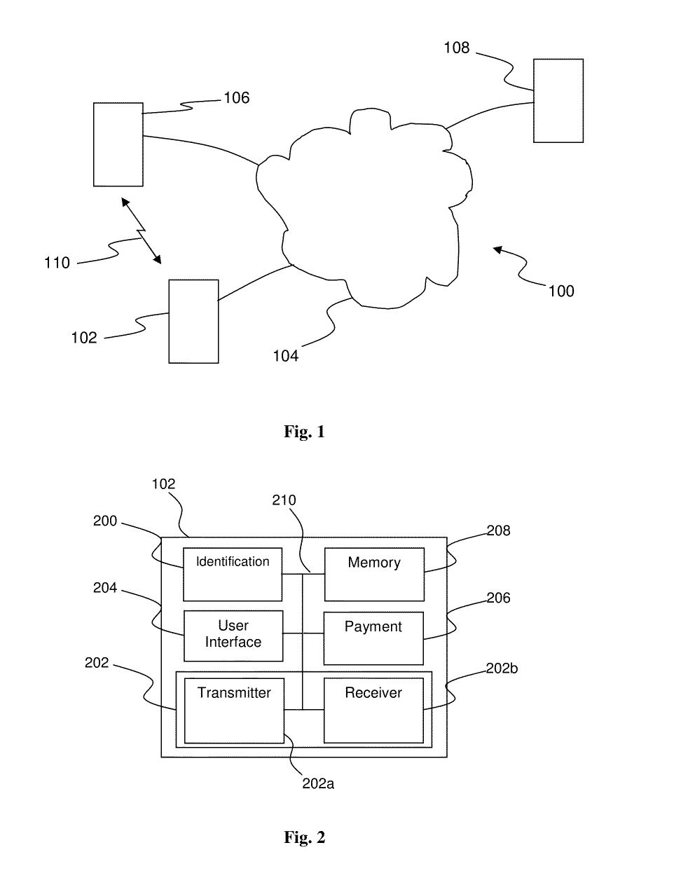

FIG. 1 shows a system 100 for vending items. The system 100 comprises a user device 102, a network 104, a vending machine 106 and a database 108.

The user device 102 may be any type of device comprising a processor and capable of communicating with other devices over a network. For example, the user device 102 may be a personal computer, laptop computer, tablet computer, PDA or smartphone. The user device is in electrical communication with a network 104. The user device is also configured to obtain identification data identifying the vending machine 106. This is explained in more detail below. The vending machine 106 is also in electrical communication with the network 104, although this is not essential for the system to operate. In addition, the database 108 is in electrical communication with the network 104. Therefore, each of the user device 102, the vending machine 106 and the database 108 are potentially in electrical communication with each other via the network 104.

Broadly speaking the user device 102 is configured to obtain data identifying the vending machine 106 and, based on the identifying data, download data relating to the contents of the vending machine 106. The data may be downloaded from the database 108 or from a database forming part of the vending machine 106, as explained below. A user then makes a user input to the user device 102 and, based on the user input, the user device 102 transmits data to update the data relating to the contents of the vending machine 106. As before, the data transmitted by the user device 102 may be transmitted to the database 108, or to a database forming part of the vending machine.

In exemplary methods and apparatus, a user may be able to vend (and, optionally, pay for) an item from the vending machine 106 using only the user device 102. In such methods and apparatus, the user may be presented with information on the user device 102 identifying the products available to vend from the vending machine 106. The user is then able simply to select whichever item(s) they wish to purchase and the item is vended from the machine 106 and paid for electronically.

Accordingly, the methods and apparatus described herein provide a more efficient and seamless user experience and allow a user to more easily obtain items from the vending machine 106. Further, more information can be provided to the user, such as nutritional information and information relating to ingredients and/or allergens, which greatly increases the value of the user experience. In addition, more flexibility is provided in terms of pricing, which can be altered centrally by altering the information downloaded to the user device 102.

Accordingly, the user may be a consumer who may input may be a selection of an item to be vended from the vending machine 106. In such cases, the user device 102 is configured to send an instruction to the vending machine 106 to vend the selected item. This may be done through existing interfaces or an additional internal device that simulates user input and may be retrofitted to existing vending machines. The user device 102 then transmits data that identifies that the selected item has been vended. The transmitted data is used to update data relating to the contents of the vending machine 106. In exemplary methods and apparatus, the user device 102 may transmit the data to the database 108, notifying the database 108 that a vend has occurred so that the database 108 may update its record of the content of the vending machine 106. In other exemplary methods and apparatus, the user device 102 may transmit the data to a database of the vending machine 106. The vending machine 106 may then transmit corresponding data to the database 108, at some time later. This ensures that the record held by the database 108 is accurate and up to date, which is desirable for vending machine operators, as it allows for efficient management of resources and accurate monitoring of sales and stock control.

In alternative methods and apparatus, the user may be a filler of a machine and the user input may also relate to an update of the contents of the vending machine 106 after it has been filled. The user may therefore fill the vending machine with new stock and amend the data downloaded from the database 108 to reflect this. The user device 102 may then transmit the amended data to the database 108 across the network 104. The amended data may comprise data reflecting a change of product on a certain line within the vending machine 106 and/or a change to pricing information for a certain line within the vending machine 106. The database may then update its record of the content of the vending machine 106. This provides the advantage that the content of the vending machine 106 as recorded on the database is accurate even following a filling operation.

Whilst use its for fillers may be considered a secondary application of the methods and apparatus disclosed herein, it does provide a solution to a specific problem. It is common for fillers to arrive at a location of a vending machine in a van containing items that may be added to the lines of a vending machine. However, the vending machine may be located a long way from the van, for instance, in a building and a number of floors up. Therefore, the filler will carry from the van the stock items he or she thinks are required to fill the vending machine. However, if the information the filler has is not correct, he or she may not have the correct items. In such circumstances, the filler may simply fill the vending machine with the stock he or she has with them, rather than the stock that is required. For example, a filler may fill a line that should contain ready salted crisps with, say, salt and vinegar crisps because they have no ready salted crisps with them. Alternatively, if they have some ready salted crisps but not enough to fill the line, they may fill some of the line with ready salted crisps, and fill the remainder of the line with salt and vinegar crisps. If this occurs, the items that the database and/or the vending machine think are stored on each line are not the same as the items that are actually stored on each line. This means that stock control and sales information derived from the database is inaccurate. In addition, the problem is perpetuated as the wrong information is given to the filler about what is required and, therefore, what he or she must take with them from the van.

By allowing the filler to amend easily the data relating to the content of the vending machine 106 using the user device 102, the correct information is transmitted to the database 108 to ensure that stock and sales data is correct.

It is noted that the database could be stored on the vending machine 106 itself and not downloaded over the network 104. In such cases, the user device 102 may download data relating to the content of the vending machine 106 from the vending machine 106. This may be done via the network 104 or via a separate communications link 110.

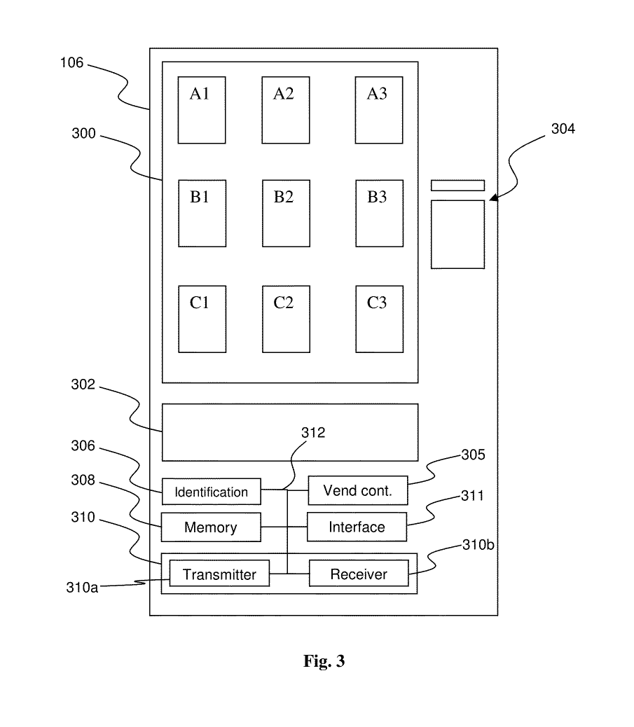

FIG. 2 shows an exemplary user device 102 comprising an identification unit 200, a communication unit 202, a user interface 204, a payment unit 206 and a memory 208. The communication unit 200 comprises a transmitter 202a and a receiver 202b. Each of the transmitter 202a, receiver 202b, identification unit 200, user interface 204, payment unit 206 and memory 208 is in electrical communication with all of the other features of the user device 102. In the exemplary user device 102 of FIG. 2, this is provided by a bus 210. The communication unit 202 is in electrical communication with the network 104. Further, the communication unit 202 may be in electrical communication with the vending machine 106. The communication unit 202 is configured to transmit and receive messages to/from the network 104 and/or the vending machine 106. The user device 102 can be implemented as a combination of computer hardware and software. In particular, the identification unit 200 and payment unit 206 may be embodied in software for running on a processor. The memory 208 may store the various programs/executable files that are implemented by a processor, and also provides a storage unit for any required data. The programs/executable files stored in the memory 208, and implemented by the processor, can include but are not limited to an identification unit 200 and a payment unit 206 that are configured to implement the methods described herein.

It is noted that the payment unit 206 is not essential for the operation of the user device 102.

The identification unit 200 is configured to obtain information identifying the vending machine 106. The identification unit 200 may use optical means for uniquely identifying the vending machine 106 such as a bar code, quick response (QR) code or similar. Therefore, the identification unit 200 may comprise a reader configured to read a bar code, QR code or any other type of visual code. As such, the identification unit 200 may comprise a light emitter and receiver. The identification unit 200 may utilise smart tags or optical picture recognition and may be configured for use with such technologies. The identification unit 200 may be configured to set up a communications link with the vending machine 106 using, for example, Bluetooth (®™) or RFID, although the methods and apparatus disclosed herein are not limited to these technologies. Therefore, the identification unit may comprise a transmitter and receiver, or may make use of the transmitter 202a and receiver 202b of the communication unit 202.

The user interface 204 may include a display screen configured to display data downloaded from the server 108 to a user. The user interface 204 may also comprise a keyboard and/or a plurality of buttons to allow a user to input data to the user device 102. The display screen may be a touchscreen configured to allow a user to make user inputs to the screen.

The payment unit 206 is configured to undertake a transaction to pay for vended items. For example, the payment unit 206 may be configured to store data relating to the details of one or more payment cards that may be used to pay for vended items. The payment unit 206 may be configured to pay for vended items by adding the cost of the item to an account that the user holds with a network service provider. The payment unit 206 may, for example, use known electronic payment methods or may use gift tokens, which may be given to, for example, children in order to obtain food.

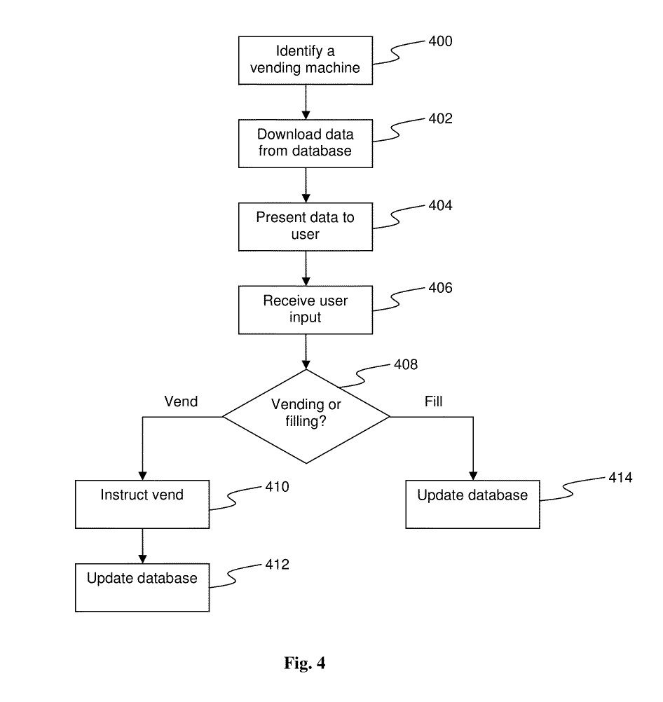

FIG. 3 shows schematically a vending machine 106 comprising a window 300 through which a user may view items in the machine 106, a dispensing tray 302 from which vended items may be retrieved by a user and a user interface 304 comprising a keypad and a display. Items to be vended may be located on lines in the vending machine 106 shown schematically as locations A1-C3. Each line may comprise an actuator configured to vend an item loaded to the line under control of a vending controller 305. Also shown in FIG. 3 are an identification unit 306, a memory 308, a communication unit 310 and a machine interface 311. The communication unit 310 comprises a transmitter 310a and a receiver 310b. It is understood that the identification unit 306, memory 308 and communication unit 310 might not be visible from the external aspect of the vending machine 106 and are shown to aid description of the operation of the vending machine 106.

Each of the transmitter 310a, receiver 310b, identification unit 306, vending controller 305, memory 308 and machine interface 311 may be in electrical communication with all of the other features of the vending machine 106. In the exemplary vending machine 106 of FIG. 3, this is provided by a bus 312. In exemplary vending machines, the transmitter 310a, receiver 310b, vending controller, identification unit 306, memory 308 and machine interface adaptor 311 at least may be provided in a separate unit within the vending machine. The separate unit may be operated by a third party and may be termed a “telematics box”. The communication unit 310 is in electrical communication with the network 104. Further, the communication unit 310 may be in electrical communication with the user device 102. The communication unit 310 is configured to transmit and receive messages to/from the network 104 and/or the user device 102. The vending machine 106 can be implemented as a combination of computer hardware and software. In particular, the identification unit 306 may be embodied in software for running on a processor. The memory 308 may store the various programs/executable files that are implemented by a processor, and also provides a storage unit for any required data. The programs/executable files stored in the memory 308, and implemented by the processor, can include but are not limited to an identification unit 306 that is configured to implement the methods described herein.

The identification unit 306 is configured to provide information identifying the vending machine 106. The identification unit 306 may use optical means for uniquely identifying the vending machine 106 such as a bar code, quick response (QR) code or similar. Therefore, the identification unit 306 may comprise a bar code, QR code or any other type of visual code positioned on the vending machine 106 and readable by a code reader of the user device 102. The identification unit 306 may utilise smart tags or optical picture recognition and may be configured for use with such technologies. The identification unit 306 may be configured to set up a communications link with the user device 102 using, for example, Bluetooth (®™) or RFID. Therefore, the identification unit 306 may comprise a transmitter and/or receiver, or may make use of the transmitter 310a and receiver 310b of the communication unit 310.

Broadly speaking, the machine interface 311 is configured to receive instructions from a user device 102 to vend a selected item, convert the received instruction to an instruction that can be understood by the vending controller 305 (commonly, this will mimic an entry on the keypad of the user interface 304) and transmit the instruction to the vending controller 305 for vending the selected item. The machine interface 311 may receive transmitted instructions from the receiver 310b, or may comprise a separate receiver and transmitter (not shown) for communication with the user device 102. In such cases the machine interface 311 and associated transmitter and receiver may form part of a discrete unit that may be retrofitted to existing vending machines. The machine interface 311 may form part of the telematics box.

That is, vending machines having no means of communicating with a user device 102 for controlling vending operations may be fitted with a machine interface 311 comprising a transmitter and receiver. The transmitter and receiver may be configured to communicate with the user device 102 and the machine interface may be configured to convert user device 102 instructions to instructions that may be understood by a vending controller 305 and transmit instructions to the vending controller 305.

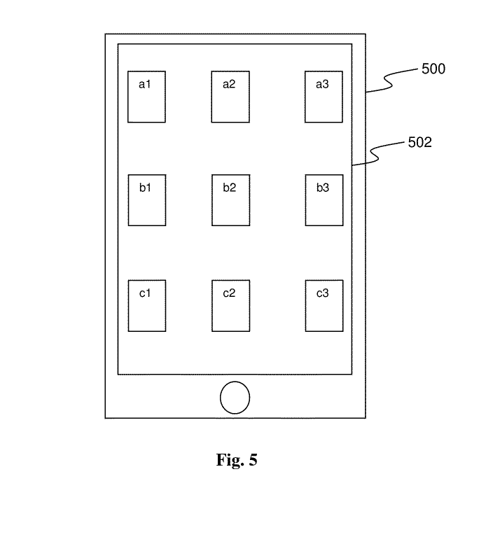

FIG. 4 shows a flow chart showing a method of operation of a system 100 for vending items from a vending machine 106. This method allows a user to vend items from the vending machine 106 using the user device 102.

The method comprises identifying 400 a vending machine 106. This may be done using optical means, such as barcodes and/or QR codes as mentioned above. In such cases, the user device 102 is held such that a code reader of the identification unit 200 is able to read a code located on the vending machine 106. The code uniquely identifies the vending machine 106. Alternatively, the vending machine 106 may be identified by a communications link. For example, the user device 102 may establish a communications link with the vending machine 102 and the vending machine 106 may transmit data to the user device 102 to identify itself. In other exemplary methods and apparatus, the user may read a code from the vending machine and manually input the code to the user device 102.

Once the vending machine 106 has been identified, the user device downloads 402 data from the database 108. For example, the user device 102 may query the database 108 to obtain data relating to the content of the vending machine 102. The data obtained may comprise one or more of the items loaded onto the lines of the vending machine 106, nutritional information about items loaded onto the lines of the vending machine 106, pricing information including special offers, ingredient information for the items loaded onto the lines of the vending machine 106 and allergen information for the items loaded onto the lines of the vending machine 106. It is noted again that the user device 102 may download data relating to the content of the vending machine 106 from the memory 308 of the vending machine 106. In this regard, the memory 308 may form a database holding data relating to the content of the vending machine 106.

Once the user device 102 has downloaded the data from the database 108, the data is presented 404 to a user. In particular methods and apparatus, the data comprises the contents of the items in the vending machine 106 and their respective locations. The user device 102 may comprise a screen and the data is displayed to the user on the screen. The data shows the contents of the vending machine 106 by displaying icons relating to each item in the location in which they appear on the lines of the vending machine. That is, the item located at position A1 in the vending machine 106 will be shown at a corresponding location a1 on the display of the user device 102.

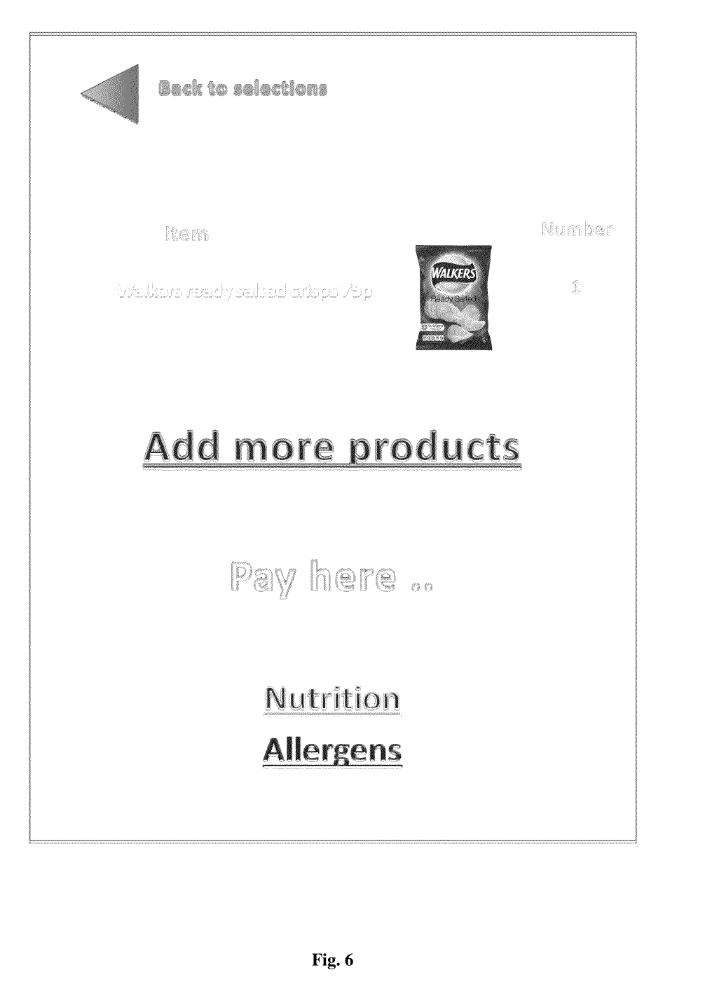

FIG. 5 shows an exemplary display of a user device 500, which is a smartphone. The user device 500 comprises a touchscreen 502, which displays the items that may be vended as icons on the screen. For example, if the location A1 in the vending machine 106 has ready salted crisps loaded onto the line, the display 502 will show a ready salted crisps icon at location a1. The same applies to the other locations of the vending machine and the screen. Therefore, once the machine is known to the smartphone, an application running on the smartphone presents a virtual vending machine layout downloaded from the machine planagram database 108. The user is now looking at a picture version of the vending machines products.

The user makes a user input, which is received 406 by the user device 102, 500. In the exemplary user device 500 of FIG. 5, the user may make a user input by touching the touchscreen 502.

It is noted that other types of user interface may be used. For example other visual or audio cues may be used to present the data to the user. In addition, the user may make other types of user input, for example an audio or voice input or a gesture input by moving the user device 102, 500 in a particular direction.

It is determined 408 whether the operation to be undertaken is a vending or a filling operation. In exemplary methods and apparatus, a vending operation may be selected by user input and the user may select an item to vend. In the exemplary user device 500 of FIG. 5, this may be done by touching the screen at a location a1-c3 at which the icon for the item the user wishes to purchase is located.

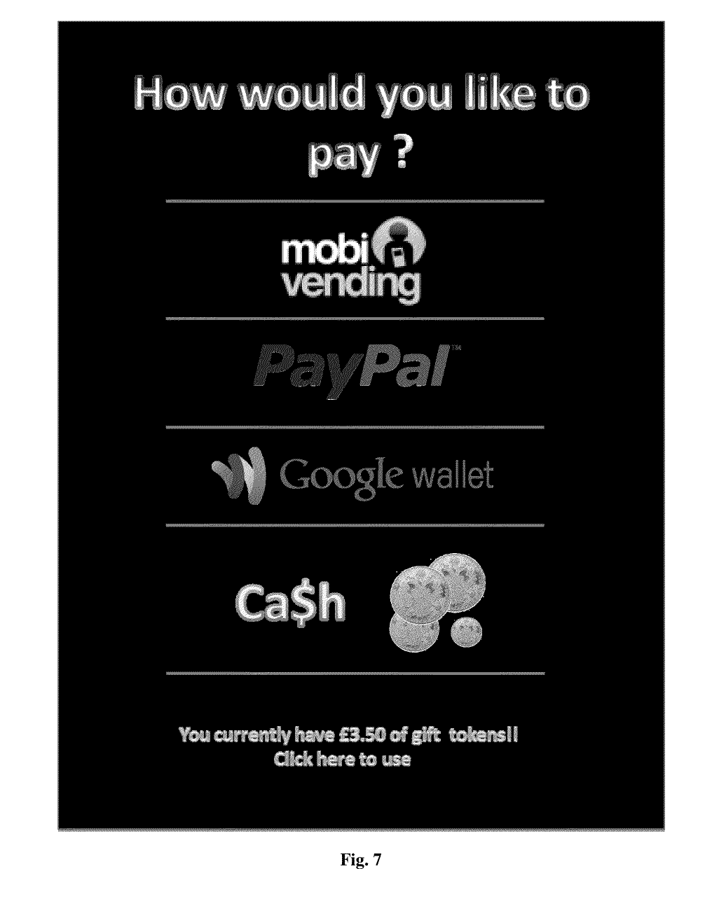

If a product is selected, the user is presented with a number of options. They can pay using a variety of electronic payment methods as described herein or they can get more information such as allergens and nutritional information. Product promotions can also be accommodated by graphically illustrating offers on the visual layout so that the consumer is drawn to those items. FIG. 6 shows an exemplary screen shot of a user device 102, 500 after a selection of ready salted crisps has been made. The icon for the selected item is shown and the user is able to select further options such as adding more products to the order, paying for the selected items and obtaining nutrition or allergen information relating to a selected item. The user may select any one of these options. It is noted that further options may be presented to the user, if required.

In a vending operation, the user device 102, 500 instructs 410 the vending machine 106 to vend the item. For example, the communication unit 202 may transmit data to the vending machine 106 to instruct the machine to vend the selected item. The data may be transmitted either over the network 104 or via a communications link between the user device 102, 500 and the vending machine 106, as discussed above.

In exemplary methods and apparatus, the vending machine may be configured to receive instructions directly from a user device 102 and vend an item based directly on the received instructions. However, a high number of vending machines exist that do not have that capability. In such vending machines, the machine interface 311 may comprise an associated transmitter and receiver that may together form part of a discrete unit that may be retrofitted to existing vending machines. The machine interface 311 is configured to receive instructions from the user device. The machine interface 311 then converts the user device 102 instructions to a format that the vending controller 305 can understand for example, an instruction that mimics a selection from the keypad of the user interface 304. The machine interface 311 then transmits the converted instruction to the vending controller 305 to vend the selected item.

The instruction to vend might not be sent until the item has been paid for. Payment may be made by inserting coins into the vending machine 106 or by electronic payment using the user device 102, 500. FIG. 7 shows an exemplary screen shot from the user device 102, 500 showing the options for electronic payment. The user may enter the desired selection and payment is undertaken.

After the vending instruction has been transmitted 410 to the vending machine 106 and the selected item has been vended, the user device 102, 500 updates 412 the database by transmitting updated data to the database 108. The database 108 receives the data and updates the content information stored in relation to the vending machine 106.

If it is determined 408 that a fill operation is to be undertaken, the user input might comprise updated content data relating to the vending machine 106. For example, a filler may place items on the lines of the vending machine 106 in order to fill each line. The user input made by the filler may then indicate which items are located in which locations A1-C3 of the vending machine 106. This may be done by a user selecting on the user device 102, 500 a particular item from a list of items and dragging and dropping the selected item into the correct location a1-c3 on a display of the device 102, 500 corresponding to the location A1-C3 in the vending machine 106. Alternatively, the user device 102, 500 may comprise a barcode scanner for scanning a barcode of an item to be placed in the vending machine 106. The user may indicate a location a1-c3 on the display screen 502 corresponding to the location A1-C3 in the vending machine 106 at which the scanned item is positioned.

When the filling operation is complete, the user device 102, 500 updates 414 the database 108. This may be done in the same way as after completion of a vending operation, as discussed above.

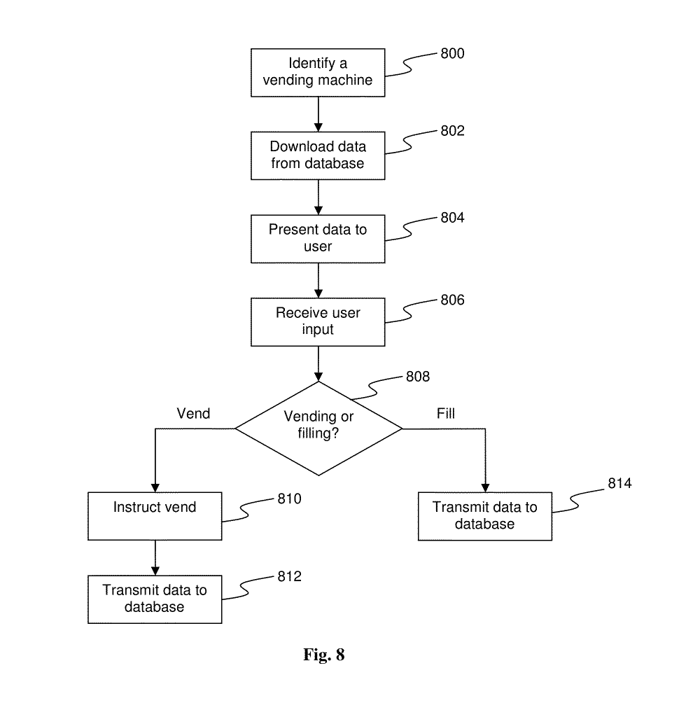

FIG. 8 shows a flow chart for a method of operating a user device 102, 500. Operations undertaken in the exemplary method of FIG. 8 may be the same as those undertaken in the method of FIG. 4.

A user device 102, 500 identifies 800 a vending machine 106 using the user device's 102, 500 identification unit 200. Based on the identification of the vending machine 106, the user device 102, 500 queries a database 108 to obtain 802 data relating to the content of the vending machine 106. The data is presented 804 to a user, for example using a display 502 of the user device 102, 500. A user input is received 806 by the user device 102, 500. If it is determined 808 that the operation is a vending operation, the user device 102, 500 transmits an instruction 810 to the vending to vend the selected item. The user device 102, 500 then transmits 812 updated data to the database 108 to indicate that the selected item has been vended. If the operation is a filling operation, the user input amends the data obtained from the database 108 according to how the filler has filled the vending machine 106. The updated data is transmitted 814 to the database 108 to indicate the content of the vending machine 106 and the location of each item contained in it.

Given that the technologies exist to communicate both with the consumer via user devices 102, 500 and with the vending machine 106, the basis of the methods and apparatus disclosed herein is to allow the consumer to take control of the machine using a user device such as a smartphone.

This method of using the processing power in the pocket of the consumer (in the shape of a smartphone or other user device) removes the need for a display screen on the vending machine and the associated costs, maintenance and vandalism risk.

A novel element of the methods and apparatus disclosed is the storage of physical product information and the presentation of that to the consumer via the Internet using a user device, such as a smartphone, that allows users to select and pay for a product without ever touching the machine. The product information may comprise an image of the product and/or ingredient information.

A computer program may be configured to provide any of the above described methods. The computer program may be provided on a computer readable medium. The computer program may be a computer program product. The product may comprise a non-transitory computer usable storage medium. The computer program product may have computer-readable program code embodied in the medium configured to perform the method. The computer program product may be configured to cause at least one processor to perform some or all of the method.

Various methods and apparatus are described herein with reference to block diagrams or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

Computer program instructions may also be stored in a computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-ray).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, the invention may be embodied in hardware and/or in software (including firmware, resident software, micro-code, etc.) that runs on a processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated.

The skilled person will be able to envisage other embodiments without departing from the scope of the appended claims.

1. A user device comprising:
an identification unit configured to obtain data identifying a vending machine;
a communication unit configured to query a database to obtain data relating to the content of an identified vending machine; and
a user interface configured to present the obtained data to a user and receive a user input relating to the content of an identified vending machine,
wherein the communication unit is further configured to transmit to a database updated data based on the user input and relating to the content of an identified vending machine.

2. A user device according to claim 1, wherein the data relating to the content of the vending machine comprises the content of the vending machine, and wherein the user interface comprises a display configured to display the contents of an identified vending machine to a user.

3. A user device according to claim 2, wherein the display is configured to display the contents of the vending machine in a layout corresponding to the layout of the contents in the vending machine.

4. A user device according to claim 1, wherein the user input comprises a selection of an item contained in an identified vending machine, and wherein the communication unit is further configured to transmit an instruction to the identified vending machine to vend the selected item.

5. A user device according to claim 4, wherein the communication unit is configured to transmit the instruction to vend to a machine interface of the vending machine.

6. A user device according to claim 4, wherein the updated data comprises data indicating that the selected item has been vended and is no longer contained in the vending machine.

7. A user device according to claim 4, further comprising a payment unit configured to pay a vendor for the selected item.

8. A user device according to claim 7, wherein the payment unit is configured to make payment using at least one of: credit or debit card information; and account information relating to a network provider service associated with the user device.

9. A user device according to claim 1, wherein the user input comprises amendments to the data relating to the content of an identified vending machine.

10. A user device according to claim 9, wherein the updated data comprises data indicating the content and location of items in the vending machine.

11. A user device according to claim 1, wherein the data obtained from the database comprises product information relating to one or more items contained in the vending machine, wherein the product information is selectably displayed to the user.

12. A user device according to claim 11, wherein the product information comprises one or more of: pricing information; special offers; nutritional information; ingredient information; allergen information; and best before date information.

13. A user device according to claim 1, wherein the identification unit comprises a communication part configured to establish a communication link with a vending machine to obtain information identifying the vending machine.

14. A method for operation of a user device, comprising:
obtaining data identifying a vending machine;
querying a database to obtain data relating to the content of an identified vending machine;
presenting the obtained data to a user and receiving a user input relating to the content of an identified vending machine; and
transmitting to a database updated data based on the user input and relating to the content of an identified vending machine.

15. A non-transitory computer readable medium comprising computer readable code configured when read by a computer to undertake the method of claim 14.

16. A vending system comprising:
a user device comprising an identification unit configured to obtain data identifying a vending machine from an identification unit of the vending machine;
the user device further comprising a communication unit configured to query a database to obtain data relating to the content of the identified vending machine, and a user interface configured to present the obtained data to a user and to receive a user input relating to the content of the identified vending machine,
wherein the communication unit of the user device is further configured to transmit to the database updated data based on the user input and relating to the content of the vending machine.

17. A vending system according to claim 16, wherein the user input comprises a selection of an item to vend from the vending machine, and wherein the communication unit of the user device is configured to transmit an instruction to the identified vending machine to vend the selected item.

18. A vending system according to claim 17, wherein the communication unit of the user device is configured to transmit the instruction to vend to a machine interface of the vending machine.

19. A vending system according to claim 18, wherein the machine interface is configured to receive an instruction to vend from the user device, generate a converted instruction to vend in a format understandable by a vending controller of the vending machine and transmit the converted instruction to vend to the vending controller.

20. A vending system according to claim 19, wherein the machine interface is configured to generate a converted instruction to vend that mimics an instruction from a keypad of a user interface of the vending machine.

21. A method comprising:
identifying a vending machine;
querying a database to obtain data relating to the content of an identified vending machine;
presenting the obtained data to a user and receiving a user input relating to the content of the vending machine;
transmitting to a database updated data based on the user input and relating to the content of the vending machine; and
updating the database based on the updated data.

22. A non-transitory computer readable medium comprising computer readable code configured when read by a computer to undertake the method of claim 21.

23. A vending machine, comprising:
an identification unit for providing information identifying the vending machine to a user device; and
a communication unit configured to receive a vending instruction from a user device, the vending machine being configured to vend an item based on the received instruction.

24. A vending machine according to claim 23, further comprising a machine interface configured to receive an instruction to vend from a user device, generate a converted instruction to vend in a format understandable by a vending controller of the vending machine and transmit the converted instruction to vend to the vending controller.

25. A vending machine according to claim 24, wherein the machine interface is configured to generate a converted instruction to vend that mimics an instruction from a keypad of a user interface of the vending machine.
